(19) United States
(12) Patent Application Publication
(10) Pub. No.: US 2003/0161634 A1
(43) Pub. Date: Aug. 28, 2003

(54) Efficient and scalable data transport system for DWDM cable TV networks

(76) Inventors: James J. Costabile, Clarksville, MD (US); Sandeep T. Vohra, Ellicott City, MD (US); Paul J. Matthews, Ellicott City, MD (US); Irl N. Duling, Lancaster, PA (US)

Correspondence Address: PILLSBURY WINTHROP, LLP, P.O. BOX 10500, MCLEAN, VA, 22102, US

(21) Appl. No.: 10/319,817

(22) Filed: Dec. 16, 2002

Related U.S. Application Data
(60) Provisional application No. 60/339,731, filed on Dec. 17, 2001.

(51) Int. Cl. H04J 4/00

(52) U.S. Cl. 398/76; 398/141

(57) ABSTRACT

Arrangements are provided for optical transport of data. A scalable data transport system has an optical transmission system having a reconfigurable bit rate; an optical transmission fiber in communication with the optical transmission system; and an optical receiver system in communication with the optical transmission fiber. The optical transmission system is adapted to modulate an optical carrier with a subcarrier-multiplexed RF signal, and the subcarrier-multiplexed RF signal comprises a selectable plurality of RF signals that can be selected to configure a bit rate of the optical transmitter and reselected to reconfigure the bit rate of said optical transmitter.

This Application is based on Provisional Application No. 60/339,731 filed Dec. 17, 2001, the entire contents of which is hereby incorporated by reference.

### BACKGROUND

1. Field of Invention

The present invention relates to systems and methods for transporting data via optical networks and optical networks employing such systems and methods, and more particularly to scalable optical networks.

2. Discussion of Related Art

Because more and more data is being generated in electronic form for business, entertainment and other private use, there is a continuing demand for faster and more reliable data traffic transport. The volume of data traffic may increase or decrease in time and fluctuate with need. Therefore, scalability has become an important requirement in data transport. In addition, the demand for bundled services on a single medium and from a single service provider also calls for a high degree of scalability in data transport to add, drop, and/or change services in a flexible manner.

Data transmission is conventionally base-band Ethernet or SONET (Synchronous Optical Network) format. Base-band Ethernet optical transport requires expensive routers for accessing lower tributaries in the system. SONET data transport is also typically expensive, requiring Ethernet to SONET format converter boxes as well as SONET grooming equipment for tributary access. With these traditional approaches, one may not be able to achieve a high degree of scalability at a reasonable cost.

Different techniques allow affordable scalability. Transporting data over a dense wavelength division multiplexed cable television network permits flexible capacity. Wavelength division multiplexing (WDM) is a technique that permits capacity increase or decrease in optical communication systems by including more or less wavelength channels. Such optical communication systems include, but are not limited to, telecommunication systems, cable television systems (CATV), and local area networks (LANs). An introduction to the field of Optical Communications can be found in “Optical Communication Systems” by Gowar, ed. Prentice Hall, N.Y., 1993.

WDM optical communication systems carry multiple optical signal channels, each channel being assigned a different wavelength. Optical signal channels are generated, multiplexed to form an optical signal comprised of the individual optical signal channels, and transmitted over a single waveguide such as an optical fiber. The optical signal is subsequently demultiplexed such that each individual channel can be routed to a designated receiver.

The WDM approach provides a level of flexibility in terms of scalability. However, there remains a need for a greater degree of scalability and flexibility than is currently provided by selecting the number of wavelength channels to combine.

### SUMMARY

In accordance with the present invention, an efficient and scalable data transport system for dense wavelength division multiplexed (DWDM) optical communications systems is provided. The data transport system according to this invention is applicable for DWDM cable TV networks.

In one embodiment, a scalable data transport system according to this invention has an optical transmission system having a reconfigurable bit rate; an optical transmission fiber in communication with the optical transmission system; and an optical receiver system in communication with the optical transmission fiber. The optical transmission system is adapted to modulate an optical carrier with a subcarrier-multiplexed RF signal, and the subcarrier-multiplexed RF signal comprises a selectable plurality of RF signals that can be selected to configure a bit rate of the optical transmitter and reselected to reconfigure the bit rate of said optical transmitter.

In some embodiments, the modulation-based data optical transport generator is constructed to first convert data into a base-band bit stream. Conversion of data in different formats such as Ethernet format, ATM (Asynchronous Transport Mode) format, SONET (Synchronous Optical Network) format, or MPEG-n (e.g., MPEG-1, MPEG-2, or MPEG-4) format can be simultaneously supported. The base-band bit stream is modulated to produce a modulated signal. Such modulated signal is then up-converted onto an RF sub-carrier at a certain frequency to produce an RF signal. An optical signal can then be generated by up-converting the RF signal onto an optical carrier.

In other embodiments, in generating an RF signal from a baseband bit stream using an RE carrier centered about a certain frequency, a frequency filter may be deployed to constrain the bandwidth required to encode the base-band bit stream. In one embodiment, the frequency filter has a static spectral profile. In another embodiment, the frequency filter has a dynamically adjustable spectral profile so that the required bandwidth may be determined on-the-fly. Different configurations may be adopted in terms of when to apply frequency filtering. In one embodiment, a frequency filter may be applied to a base-band bit stream before the base-band bit stream is modulated. In a different embodiment, frequency filtering may be applied to a modulated signal generated from the base-band bit stream before the modulated signal is up-converted onto an RF carrier. In another different embodiment, frequency filtering may also be applied to an RF signal after the modulated signal is up-converted onto an RF carrier.

In another embodiment, an optical transmission system according to this invention has a data transceiver and an optical transmitter in communication with the data transceiver. The optical transmitter is adapted to modulate an optical carrier with a subcarrier-multiplexed RF signal, and the subcarrier-multiplexed RF signal comprises a selectable plurality of RF signals that can be selected to configure a bit rate of the optical transmitter and reselected to reconfigure the bit rate of the optical transmitter.

In another embodiment, an optical receiver unit has an optical receiver; an RF splitter in communication with the optical receiver; an RF down-converter in communication with the RF splitter; and a demodulator in communication with the RF down-converter. The demodulator is adapted to produce a base-band bit stream from the down-converted RF signal, and the RF splitter is adapted to receive other RF signals that are selectable in number to configure a received bit rate of said optical receiver unit.

In accordance with yet another embodiment of the invention, a method for data transport includes selecting a number of RF signals according to a desired data transport rate; multiplexing the number of RF signals to produce an aggregated, multilevel RF signal; modulating an optical carrier with the aggregated, multilevel RF signal to produce an optical signal; transmitting the optical signal from a first location to a second location; and receiving the optical signal when it reaches the second location. The number of RF signals in this embodiment can be reselected to reconfigure the data transport rate.

### BRIEF DESCRIPTION OF THE DRAWINGS

The invention claimed and/or described herein is further described in terms of exemplary embodiments. These exemplary embodiments are described in detail with reference to the drawings. These embodiments are non-limiting exemplary embodiments, in which like reference numerals represent similar parts throughout the several views of the drawings, and wherein:

FIG. 1 depicts an exemplary scalable data transport system according to an embodiment of the present invention;

FIG. 2(a) depicts an exemplary internal structure of a data transceiver at a transmitting end according to an embodiment of the present invention;

FIG. 2(b) depicts an exemplary internal structure of a data transceiver at a receiver end according to an embodiment of the present invention;

FIG. 3 depicts an exemplary architecture for an optical transmitter according to an embodiment of the present invention;

FIG. 4 illustrates an exemplary schematic illustration of an RF spectrum according to the invention;

FIG. 5(a) shows an exemplary implementation of modulating a base-band bit stream to produce a corresponding RF signal according to an embodiment of the present invention;

FIG. 5(b) shows a different exemplary implementation of modulating a base-band bit stream to produce a corresponding RF signal according to an embodiment of the present invention;

FIG. 5(c) shows another exemplary implementation of modulating a base-band bit stream to produce a corresponding RF signal according to an embodiment of the present invention;

FIG. 5(d) illustrates an exemplary implementation of modulation and RF up-conversion that supports processing of multiple streams according to an embodiment of the present invention;

FIG. 6 depicts an exemplary architecture of an optical receiver according to an embodiment of the present invention;

FIG. 7 is an exemplary flowchart of a method of transporting data according to an embodiment of the present invention;

FIG. 8 is an exemplary flowchart of another method according to an embodiment of the present invention; and

FIG. 9 is an exemplary flowchart of another method according to an embodiment of the present invention.

### DETAILED DESCRIPTION

The present invention provides a scalable architecture for transmitting data over DWDM cable TV networks. A scalable optical transmission system according to this invention generates an optical signal containing data encoded therein and sends the optical signal to a receiving end via an optical transmission fiber. An optical receiver system receives and decodes the optical signal to recover the data encoded therein. The optical transmission system modulates an optical carrier with a subcarrier-multiplexed RF signal. (The term “optical” is to be interpreted in its broad sense herein to refer to both visible and non-visible regions of the electromagnetic spectrum, such as infra-red and ultraviolet light. Infrared light is currently commonly used in optical communication systems.) A plurality of RF carriers is each modulated with a lower data rate signal, e.g., <200 MHz, than what can be carried in an optical signal. The plurality of modulated RF signals are multiplexed and then used to modulate an optical carrier. In order to increase, or scale up, the bit rate, one can modulate a greater number of RF signals prior to multiplexing them and using them to modulate the optical carrier. Conversely, one would use fewer RF signals to obtain a decreased bit rate. This process can be repeated until the RF signals fill the bandwidth of the optical channel. The bandwidth of each RF signal may be the same, or they could have different bandwidths, providing flexibility and efficiency. The spacing between the subcarriers could be fixed, or variable. When the bandwidth of the optical channel is full, one may add optical channels to further increase the data transport rate.

The exemplary embodiments described in detail herein modulate optical carriers with subcarrier multiplexed RF signals. This invention is not limited to using only subcarrier multiplexed RF signals. For instance, subcarrier multiplexed signals may also be multiplexed with a single, filtered baseband digital signal. The general concepts of this invention are not limited to the particular frequency of the subcarriers.

The optical transmission system may also be constructed to modulate data of various native formats. In this case, data in a certain format is converted into a base-band bit stream, which is modulated and up-converted onto an RF carrier to produce an RF signal. The RF signal is then up-converted onto an optical carrier to produce an optical signal that can be optically transported. In the following detailed description, the terms “upconverter” and “downconverter” are not limited to specific types of up/downconverters. They may be of any generally accepted design (i.e. single, double, triple, etc. stage). The bandwidth of the RF carrier may be controlled via frequency filtering. Frequency filtering can be used to space RF signals closer together in frequency space, thus increasing efficiency.

The optical receiver system recovers optically transported data. An optical signal received via an optical communication network is first down-converted from the optical signal to a multiplexed RF signal, which is then split into component RF signals. The RF signal can then be down-converted to an intermediate frequency or directly to base-band. A base-band bit stream can be recovered from each RF signal to recover the corresponding data. The splitting of the multiplexed RF signal into its component RF signals can occur simultaneously with the downconversion process by power splitting the multiplexed RF signal to the multiple downconverters and selecting the desired RF subcarrier in the downconverter.

The processing described herein may be performed by a properly programmed general-purpose computer alone or in connection with a special purpose computer. Such processing may be performed by a single platform or by a distributed processing platform. In addition, such processing and functionality can be implemented in the form of special purpose hardware or in the form of software or firmware being run by a general-purpose or network processor. Data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, computer-readable media may comprise any form of data storage mechanism, including such existing memory technologies as well as hardware or circuit representations of such structures and of such data.

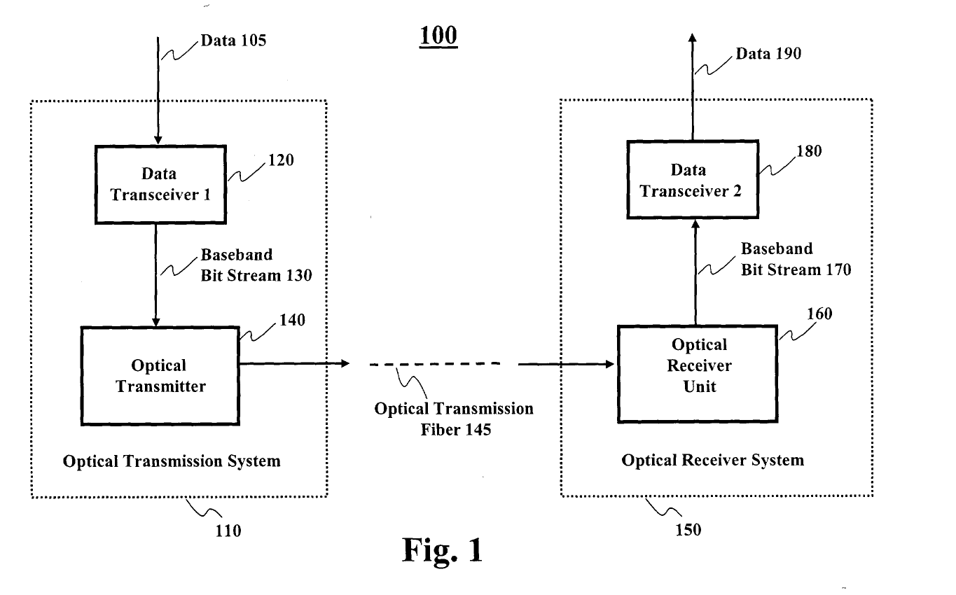

FIG. 1 depicts an exemplary scalable data transport system 100, according to an embodiment of the present invention. The scalable data transport system 100 comprises an optical transmission system 110 and an optical receiver system 150. The optical transmission system 110 transports data to the optical receiver system 150 via optical fiber 145. The optical transmission system 110 takes data 105 as input and generates an optical signal encoding the data 105 and transports the optical signal via the optical fiber 145 to the optical receiver system 150. Upon receiving the optical signal, the optical receiver system 150 decodes the optical signal to produce recovered data 190.

The optical transmission system 110 comprises a data transceiver 1 120 and an optical transmitter 140. The data transceiver 1 120 converts the data 105 into a base-band bit stream 130 which is then directed to the optical transmitter 140 so that an optical signal can be generated based on the bit stream. The optical transmitter 140 produces an optical signal corresponding to the base-band bit stream 130 by modulating an optical carrier with information contained in the bit stream 130.

At the receiving end, the optical receiver system 150 comprises an optical receiver unit 160 and a data transceiver 2 180. The optical receiver unit 160 produces a recovered base-band bit stream 170. The data transceiver 2 180 then converts the recovered base-band bit stream 170 to produce the recovered data 190.

The data to be transported via the system 100 may be in different formats. For example, the data 105 may be in Ethernet format, fast Ethernet format, ATM format, SONET format, or MPEG-n format. The system 100 may be constructed to support optical transport of data in different formats. Specifically, the data transceivers at both the transmission and the receiving ends may be designed to support a plurality of data formats. In addition, the system 100 may be constructed to support multiple streams of data in different formats.

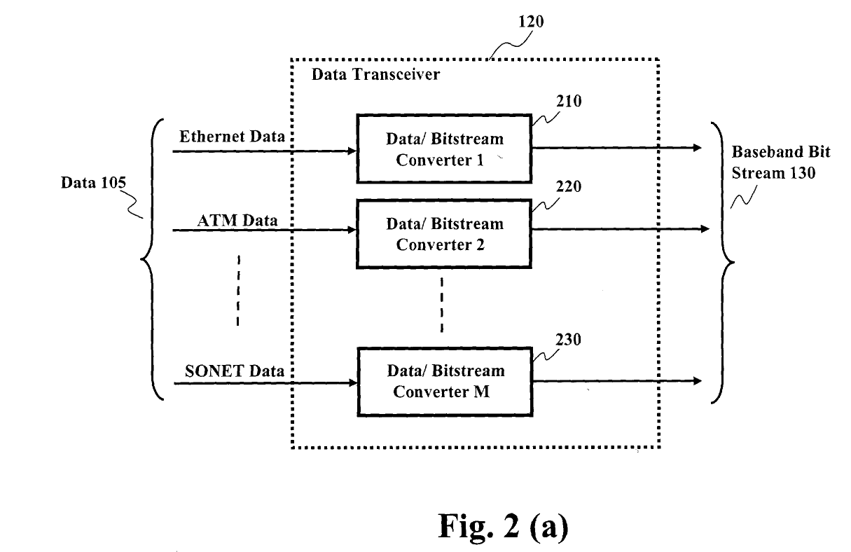

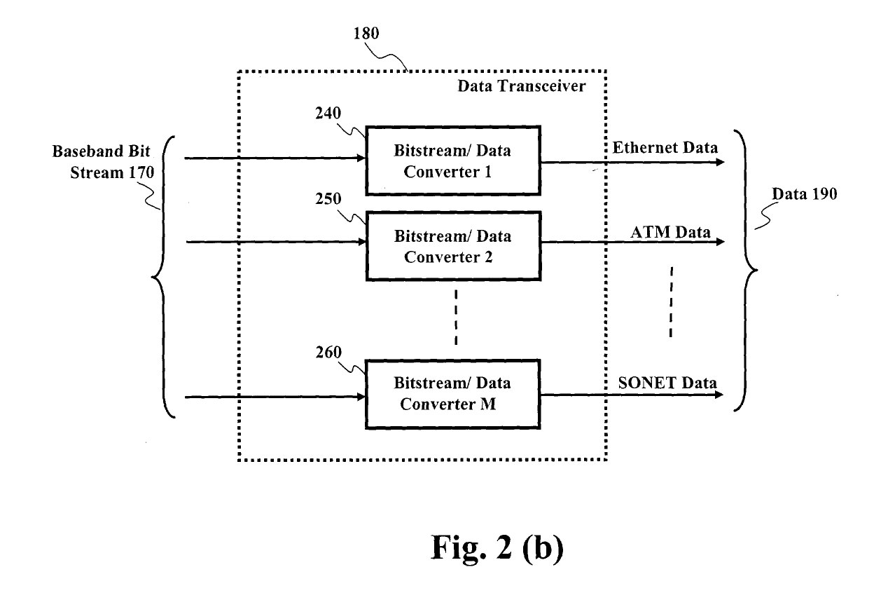

FIG. 2(a) depicts an exemplary internal structure of the data transceiver 1 120, according to an embodiment of the present invention. One or more data/bit-stream converters (e.g., data/bit-stream converter 1 210, data/bit-stream converter 2 220, . . . , data/bit-stream converter M 230) may be deployed, each of which supports conversion from data in a particular format to a corresponding base-band bit stream. For example, in FIG. 2(a), the data/bit-stream converter 1 210 may support the conversion of data in Ethernet format to a base-band bit stream. The data/bit-stream converter 2 220 may support the conversion of data in ATM format to a base-band bit stream. The data/bit-stream converter M 230 may support the conversion of data in SONET format to a base-band bit stream.

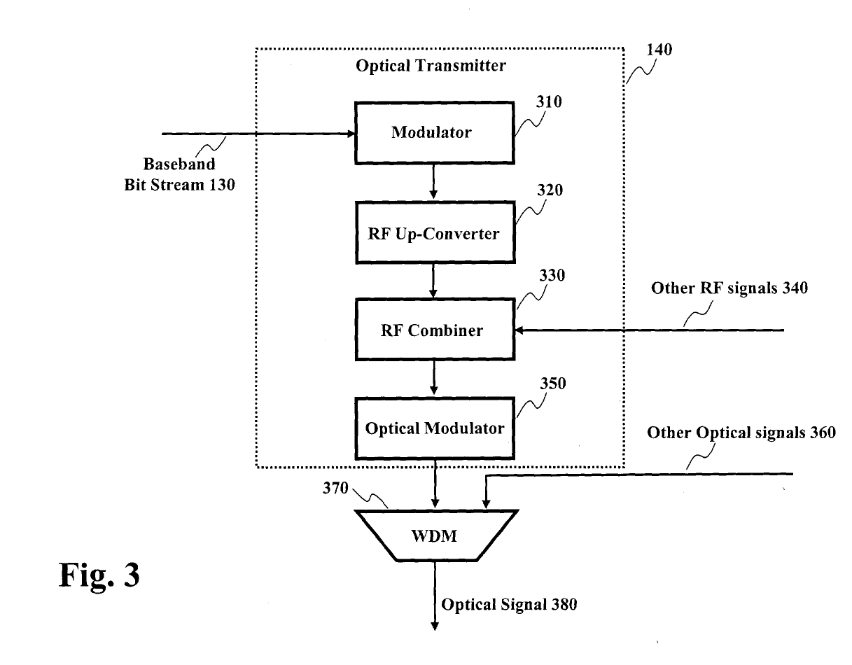

Different data/bit-stream converters may operate in parallel, each generating a distinct base-band bit stream. Such base-band bit streams generated in parallel may also be further processed in parallel in the optical signal transmitter 140. Details related to the optical transmitter 140 will be discussed with reference to FIGS. 3-6.

FIG. 2(b) depicts an exemplary internal structure of the data transceiver 2 180, according to an embodiment of the present invention. One or more bit-stream/data converters (e.g., bit-stream/data converter 1 240, bit-stream/data converter 2 250, . . . , bit-stream/data converter M 260) may be deployed, each of which supports conversion from a base-band bit stream to corresponding data in a particular format. For example, the bit-stream/data converter 1 240 may support the conversion between a base-band bit stream and data in Ethernet format. The bit-stream/data converter 2 250 may support the conversion between a bit stream and data in ATM format. The bit-stream/data converter M 260 may support the conversion between a bit stream and data in SONET format.

A data transceiver may also be designed to be capable of bi-directional conversion (not shown). In this case, each of the converters in the data transceiver may support conversions from both data in a certain format to a base-band bit stream and from a base-band bit stream to data of a particular format.

FIG. 3 depicts an exemplary architecture for the optical transmitter 140, according to an embodiment of the present invention. The optical transmitter 140 comprises a plurality of components such as a modulator 310, an RF up-converter 320, an RF combiner 330, and an optical modulator 350. The optical signal from optical transmitter 140 may be directed to a wavelength division multiplexer 370 to be combined with other optical signals. Each of the components performs certain processing at a particular stage in generating an optical signal 380 based on the input base-band bit stream 130. If only a single optical channel will be used, then the wavelength division multiplexer 370 is not needed.

The modulator 310 first modulates a carrier with the base-band bit stream 130 to generate a modulated signal. If an intermediate frequency (IF) carrier is used, the modulated IF signal is up-converted by up-converter 320 to an RF signal. In either case, the resultant RF signal may be combined or multiplexed by RF combiner 330 with other RF signals 340 to produce a single sub-carrier multiplexed RF signal. Additional line cards may be added to provide the desired number and type of other RF signals 340. This can provide a “pay as you grow” system in which line cards are added when the additional capacity is needed.

To generate an optical signal, the optical modulator 350 further up-converts the RF signal onto an optical carrier. This produces an optical signal which is encoded with the original data 105. Similarly, this optical signal may be further multiplexed with other optical signals (carried in different wavelength channels) by the wavelength division multiplexer 370 to generate a wavelength division multiplexed optical signal 380. A plurality of optical transmitters similar to optical transmitter 140 may be used to provide the plurality of optical signals.

The RF up-converter 320 may be designated to up-convert a modulated signal from the modulator 3 1 0 onto a pre-determined RF sub-carrier. For example, data of a particular format may be pre-determined to be up-converted onto a designed RF sub-carrier. When data of different formats are modulated, the resultant modulated signals corresponding to data of different formats may be up-converted to different RF sub-carriers. Alternatively, modulated signals may also share the use of the same RF sub-carrier. This allocation scheme may be practical when there is only one data stream at any given time.

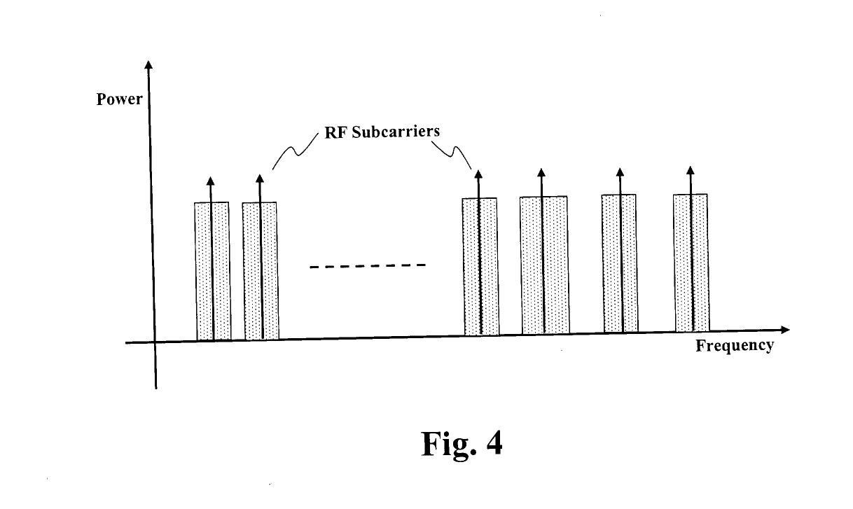

FIG. 4 illustrates an exemplary allocation schematic for RF sub-carriers along an RF spectrum. There are a plurality of RF sub-carriers, each of which has a different frequency (represented by the location, along the X-axis, of a spike associated with each block in FIG. 4) with a certain bandwidth (represented by the width of each block in FIG. 4). The bandwidth of different RF sub-carriers may be determined according to application needs and can, but do not have to be all the same. For example, if a particular RF sub-carrier is designated to carry low bandwidth data (e.g., textual data such as e-mail), it may be allocated a smaller bandwidth.

As an example, each RF sub-carrier may carry 10 MHz (10 Base T) or 100 MHz (100 Base T) Ethernet traffic. When multiple RF sub-carriers are used, such RF sub-carriers may need to be properly populated or allocated. The allocation decision may rely on different factors. For example, it may relate to desired transmission quality or amounts of data to be transported. To avoid cross talk, it may be desirable to distribute different RF sub-carriers sparsely. On the other hand, to transport a large amount of data, it may be desirable to distribute RF sub-carriers densely. Decisions related to allocating RF carriers may also be related to the available bandwidth of an underlying optical carrier.

If the required bandwidth of a particular kind of data varies in operation, certain measures may be adopted to allocate associated RF bandwidth. For example, a higher bandwidth may be allocated to the underlying RF sub-carrier to ensure coverage. A different approach may involve the use of a frequency filter with a static spectral profile. Data may be filtered (so that only the frequency components within the spectral profile will pass) to control the actual bandwidth. Frequency filters with a static spectral profile include, but are not limited to, a Nyquist filter, a raised cosine filter, or a Gaussian filter.

Alternatively, bandwidth requirements may also be determined on-the-fly. This may be achieved by filtering the data being transported using a filter with an adjustable spectral profile. Examples of such filters include a digital FFT filter (Fast Fourier Transformation) or a digital FPGA (Field Programmable Gate Array) filter.

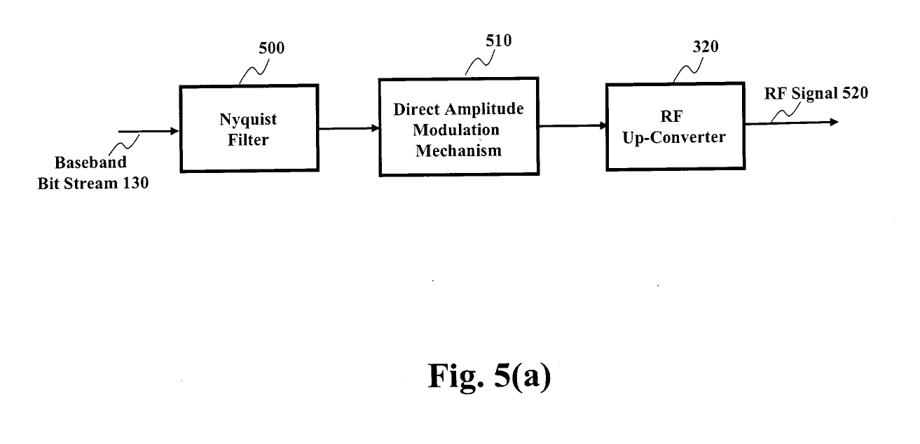

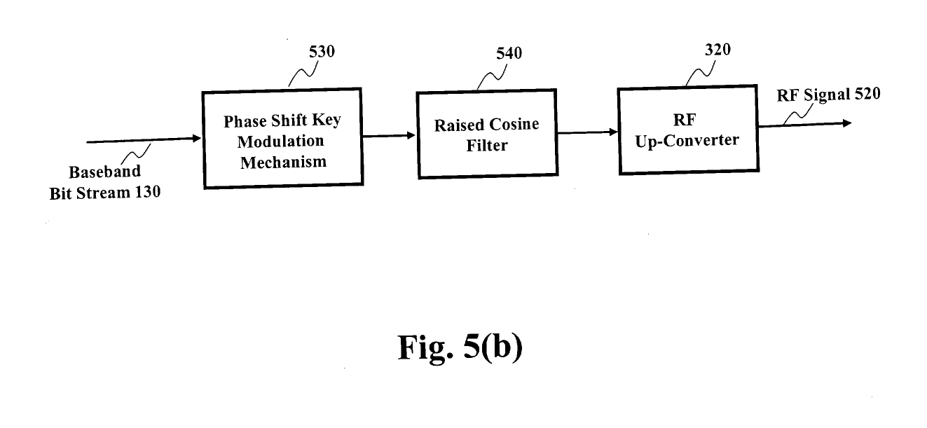

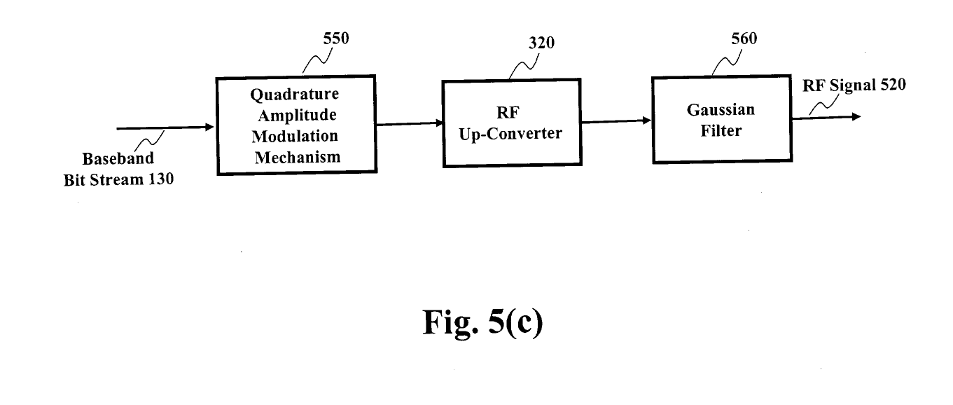

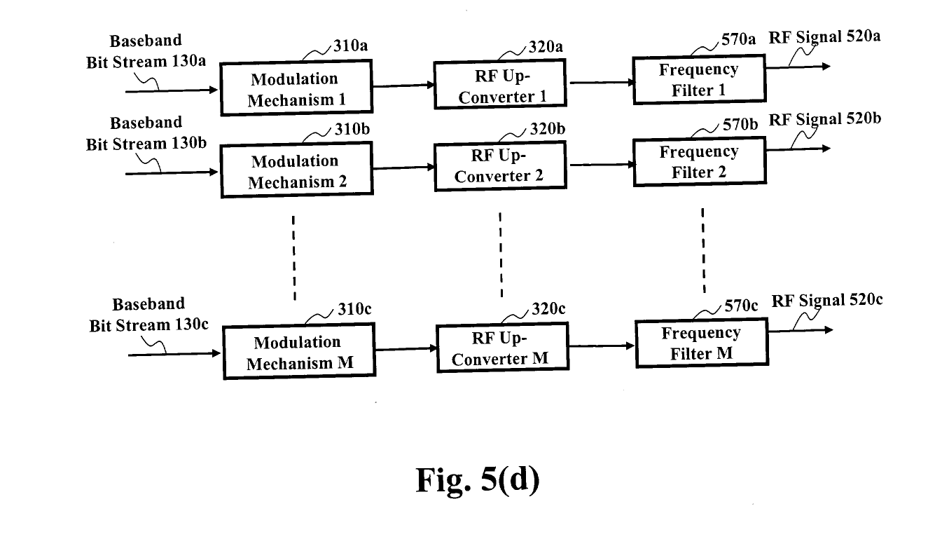

FIG. 5(a) shows an exemplary implementation of modulating a base-band bit stream to produce a corresponding RF signal, according to an embodiment of the present invention. In this embodiment, the base-band bit stream 130 is filtered before it is modulated and modulation is performed using a direct modulation approach. A Nyquist filter 500 is deployed to filter the base-band bit stream 130. The filtered signal may contain only certain frequency components. Such a filtered signal is then directed to a direct amplitude modulation mechanism 510 (an implementation of the modulator 310) to be modulated. The modulated signal is then directed to the RF up-converter 320 to be up-converted onto an RF sub-carrier to produce an RF signal 520.

FIG. 5(b) shows a different exemplary implementation of modulating a base-band bit stream to produce a corresponding RF signal, according to another embodiment of the present invention. In this embodiment, the base-band bit stream 130 is modulated first based on phase shift key modulation and the modulated signal is then filtered before it is up-converted onto an RF sub-carrier. A phase shift key modulation mechanism 530 modulates the base-band bit stream 130. The modulated signal is directed to a raised cosine filter 540. The filtered modulated signal is then directed to the RF up-converter 320 to be up-converted.

FIG. 5(c) shows another exemplary implementation of modulating a base-band bit stream to produce a corresponding RF signal according to another embodiment of the present invention. In this embodiment, the underlying signal is filtered after it is modulated and up-converted. The base-band bit stream 130 is modulated by a quadrature amplitude modulation mechanism 550. The resultant modulated signal is then directed to the RF up-converter 320 and is up-converted onto an RF sub-carrier. This produces an RF signal which is then filtered by a Gaussian filter 560 to produce a filtered RF signal.

In each of the three configurations (discussed above) of the modulator 310, the RF up-converter 320, and the frequency filter, specific implementations of the modulator 310 and the frequency filter are used for illustration purposes. It should be appreciated by one skilled in the art that such illustrations do not represent limitations. Any appropriate modulation techniques known in the art may be used to implement the modulator 310 in any of the described configurations. Similarly, any appropriate frequency filtering techniques may be used as desired to implement the frequency filter in any one of the above described configurations.

FIG. 5(d) illustrates an exemplary implementation of modulation and RF up-conversion that supports multiple streams, according to an embodiment of the present invention. In this embodiment, there are a plurality of pipelines of a modulator, an RF up-converter, and a frequency filter (e.g., a first pipeline of a modulator 1 310a, an RF up-converter 1 320a, and a frequency filter 1 570a, a second pipeline of a modulator 2 310b, an RF up-converter 2 320b, and a frequency filter 2 570b, . . . , the Mth pipeline of a modulator M 310c, an RF up-converter M 320c, and a frequency filter M 570c). Each pipeline processes one base-band bit stream. The first pipeline processes a base-band bit stream 130a. The second pipeline processes a base-band bit stream 130b. The third pipeline processes a base-band bit stream 130c. Although each pipeline in FIG. 5(d) is illustrated using the configuration of modulation first, RF up-conversion second, and frequency filtering last, any other configuration described above may also apply.

RF signals generated by different pipelines (e.g., RF signal 520a, RF signal 520b, . . . , RF signal 520c) can be combined. In FIG. 3, this is achieved by the RF combiner 330 to produce a sub-carrier multiplexed RF signal. This allows data aggregation at RF sub-carrier level. The aggregated RF signal is then up-converted by the optical modulator 350 to produce an optical signal.

When data aggregation at optical level is also in operation, the WDM 370 multiplexes the optical signal produced by the optical modulator 350 with other optical signals (which may be generated elsewhere in spatially separated wavelength channels) to produce a wavelength division multiplexed optical signal 380. A dense wavelength division multiplexer (DWDM) may also be deployed (in place of the WDM 370) to allow further aggregation to increase the data transport rate.

When the optical signal (multiplexed or not) is transported over the optical fiber 145 (FIG. 1), the optical receiver 160 decodes the optical signal to recover the data.

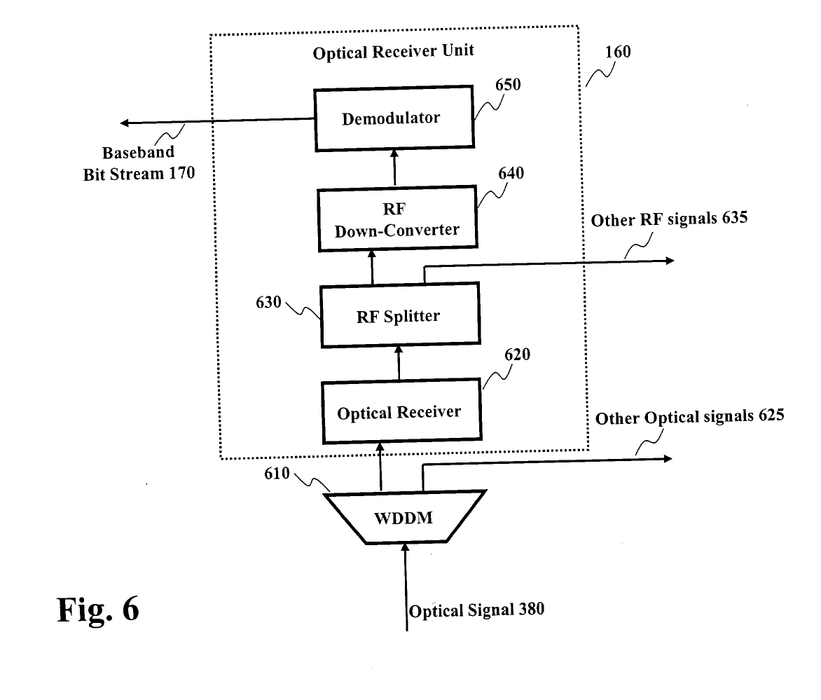

FIG. 6 depicts an exemplary architecture of the optical receiver unit 160, according to an embodiment of the present invention. The optical receiver unit 160 comprises an optical receiver 620, an RF splitter 630, an RF down-converter 640, and a demodulator 650. A wavelength division demultiplexer 610 may also be included when WDM signals may be used. The wavelength division demultiplexer 610 demultiplexes the transported optical signal 380 to produce a plurality of optical signals, each corresponding to a different wavelength channel. Some of such optical signals may contain the data 105. Such optical signals are directed to the optical receiver 620. A plurality of optical receiver units similar to optical receiver unit 160 may be provided to receive a plurality of optical channels.

The optical receiver 620 converts an optical signal into an RF signal. Such an RF signal may be further split into a plurality of RF signals on different RF sub-carriers. This is achieved by the RF splitter 630. As more RF signals are combined prior to modulating the optical signal, additional line cards may be added to accommodate the additional RF signals. The RF signals are then down-converted, by the RF down-converter 640, into modulated signals. The demodulator 650 then demodulates the modulated signals to produce the base-band bit stream 170. The data transceiver 2 180 then converts the base-band bit stream 170 to produce the data 190, corresponding to the recovered version of the data 105 (FIG. 1).

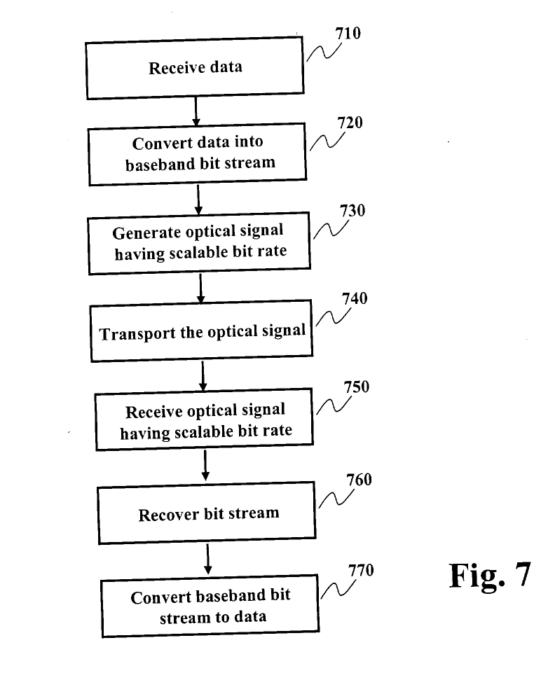

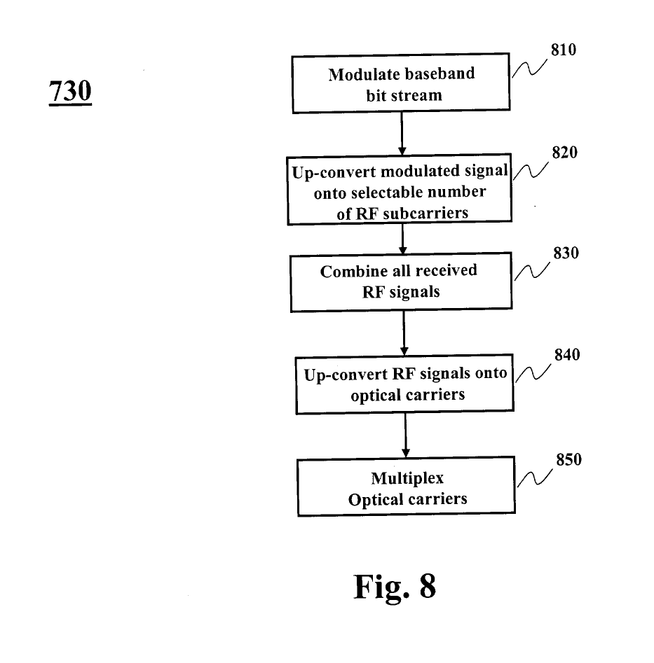

FIG. 7 is a flowchart of an exemplary process according to an embodiment of the present invention. Upon receiving data to be transported 710, the data is converted into a base-band bit stream. The base-band bit stream is used to generate an optical signal having a scalable bit rate 730. The optical signal is transported 740 to a desired location where it is received 750. The base-band bit stream is recovered 760 and then converted 770 to recover the data. The process of generating an optical signal from a base-band bit stream is described in detail with reference to FIG. 8.

FIG. 8 is a flowchart of an exemplary process, in which a base-band bit stream is modulated to generate an optical signal for modulation-based optical data transport, according to embodiments of the present invention. The base-band bit stream is first modulated 810 and then up-converted 820 onto an RF sub-carrier to produce an RF signal. The RF signal is combined 830 with other RF signals to produce a frequency division multiplexed RF signal. The number of the RF signals is selected according to a desired bandwidth. The number can be reselected to reconfigure the bandwidth used. To enable optical transport, the frequency division multiplexed RF signal is optically modulated 840 to generate an optical signal. When a plurality of optical signals are present, multiple optical signals are then multiplexed 850 to produce a single optical signal before it is optically transported. The number of optical signals that are multiplexed may also be selected according to the desired capacity.

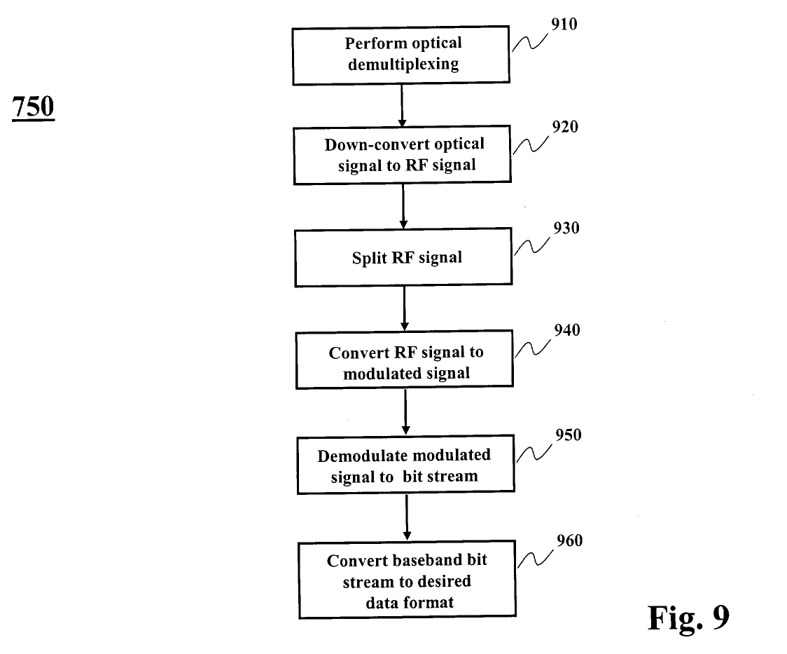

FIG. 9 is a flowchart of an exemplary process in which a transported optical signal is processed to recover encoded data according to an embodiment of the present invention. Upon receiving a transported optical signal encoded with data, wavelength division demultiplexing is performed 910, where the received optical signal contains a plurality of wavelength channels. Each of the demultiplexed optical signals corresponding to a different wavelength channel is down-converted 920 to recover an RF signal. When the down-converted RF signal is a frequency division multiplexed RF signal, it is further demultiplexed 930 into a plurality of RF signals, each corresponding to a different RF sub-carrier.

An RF signal on an RF sub-carrier is further down-converted 940 to produce a corresponding modulated signal which is then demodulated 950 to recover a base-band bit stream. The recovered base-band bit stream is then converted 960 to recover data in its initial format.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

We claim:

1. A scalable data transport system, comprising:
an optical transmission system having a reconfigurable bit rate;
an optical transmission fiber in communication with the optical transmission system; and
an optical receiver system in communication with the optical transmission fiber,
wherein said optical transmission system is adapted to modulate an optical carrier with a sub-carrier-multiplexed RF signal, and
wherein said sub-carrier-multiplexed RF signal comprises a selectable plurality of RF signals that can be selected to configure a bit rate of said optical transmitter and reselected to reconfigure said bit rate of said optical transmitter.

2. The scalable data transport system according to claim 1, wherein an RF signal from said selectable plurality of RF signals comprises data up-converted from at least one of:
Ethernet format data;
fast Ethernet format data;
asynchronous transport mode (ATM) format data;
Moving Picture Expert Group (MPEG) format data;
Motion Joint Photographic Experts Group (M-JPEG) format data; and
Voice over IP (VoIP) format data.

3. The scalable data transport system according to claim 1, wherein the optical transmission system comprises:
a data transceiver; and
an optical transmitter in communication with the data transceiver, said optical transmitter having said reconfigurable bit rate,
wherein the data transceiver is adapted to convert data in an initial format into a base-band bit stream, and
the optical transmitter is constructed to generate an optical signal based on at least said base-band bit stream.

4. The scalable data transport system according to claim 3, wherein the data transceiver comprises a plurality of data/bit-stream converters, wherein each data/bit-stream converter is adapted to convert input data into a base-band bit stream.

5. The scalable data transport system according to claim 3, wherein the optical transmitter comprises:
a modulator in connection with the data transceiver;
a radio frequency (RF) up-converter in communication with the modulator; and
an optical modulator in communication with the RF up-converter,
wherein the modulator is adapted to modulate the base-band bit stream from the data transceiver to produce a modulate signal,
the RF up-converter is constructed to up-convert the modulated signal onto an RF sub-carrier to produce an RF signal, and
the optical modulator is adapted to up-convert the RF signal onto an optical carrier to produce the optical signal centered on an optical channel wavelength.

6. The scalable optical system according to claim 5, further comprising a frequency filter constructed to perform frequency filtering to constrain the bandwidth of the RF signal.

7. The scalable optical system according to claim 5, further comprising an RF combiner having signal inputs from said RF up-converter and other RF signals and a signal output to said optical modulator, wherein said RF combiner is structured to multiplex the RF signal generated by the RF up-converter with the other RF signals carried on different RF sub-carriers.

8. The scalable optical system according to claim 5, further comprising a wavelength division multiplexer arranged to receive said optical signal from said optical transmitter and at least one other optical signal, wherein said wavelength division multiplexer is structured to multiplex the optical signal from the optical modulator with said at least one other optical signal corresponding to a different wavelength channel from the first-mentioned wavelength channel.

9. The scalable optical system according to claim 1, wherein the optical receiver system comprises:
an optical receiver unit; and
an output data transceiver in communication with the optical receiver,
wherein the optical receiver unit is adapted to recover a base-band bit stream from the optical signal received, and
the output data transceiver is adapted to convert the recovered base-band bit stream into an output data format.

10. The scalable optical system according to claim 9, wherein the optical receiver unit further comprises:
an optical receiver,
an RF down-converter in communication with the optical receiver; and
a demodulator in communication with the RF down-converter,
wherein the optical receiver is constructed to receive said optical signal and produce a recovered RF signal,
the RF down-converter is constructed to down-convert the recovered RF signal to produce a recovered modulated signal, and
the demodulator is adapted to demodulate the recovered modulated signal to produce the recovered base-band bit stream.

11. The scalable optical system according to claim 10, further comprising a wavelength division demultiplexer arranged to receive said optical signal from said optical transmission fiber and output a plurality of demultiplexed optical signals in different wavelength channels, wherein one of the demultiplexed optical signals is received by said optical receiver.

12. The scalable optical system according to claim 11, further comprising an RF splitter in communication with said optical receiver, wherein said RF splitter is constructed to split an RF signal into a plurality of RF signals.

13. An optical transmission system, comprising:
a data transceiver; and
an optical transmitter in communication with the data transceiver,
wherein said optical transmitter is adapted to modulate an optical carrier with a sub-carrier-multiplexed RF signal, and
wherein said sub-carrier-multiplexed RF signal comprises a selectable plurality of RF signals that can be selected to configure a bit rate of said optical transmitter and reselected to reconfigure said bit rate of said optical transmitter.

14. The optical transmission system according to claim 13, wherein the data transceiver is adapted to convert data from a data format to a base-band bit stream, wherein the data format is at least one of:
an Ethernet format;
a fast Ethernet format;
an asynchronous transport mode (ATM) format;
a Moving Picture Expert Group (MPEG) format;
a Motion Joint Photographic Experts Group (M-JPEG) format; and
a Voice over IP (VoIP) format.

15. The optical transmission system according to claim 13, wherein the data transceiver comprises at least one data/bit-stream converter, wherein each data/bit-stream converter is adapted to convert the data in a data format into a base-band bit stream.

16. The optical transmission system according to claim 13, wherein the optical transmitter comprises:
a modulator in connection with the data transceiver;
a radio frequency (RF) up-converter in communication with the modulator; and
an optical modulator in connection with the RF up-converter,
wherein the modulator modulates the base-band bit stream from the data transceiver to produce a modulated signal,
the RF up-converter is constructed to up-convert the modulated signal onto an RF sub-carrier to produce said RF signal, and
the optical modulator is adapted to up-convert the RF signal onto an optical carrier to produce the optical signal.

17. The optical transmission system according to claim 16, wherein the modulator comprises at least one of:
a direct amplitude modulator;
a phase shift key modulator; and
a quadrature amplitude modulator.

18. The optical transmission system according to claim 16, further comprising a frequency filter capable of performing frequency filtering to constrain bandwidth required for the RF sub-carrier.

19. The optical transmission system according to claim 18, wherein the frequency filtering is performed on the base-band bit stream before the modulator modulates the base-band bit stream.

20. The optical transmission system according to claim 18, wherein the frequency filtering is performed on the modulated signal generated by the modulator before the RF up-converter up-converts the modulated signal onto the RF sub-carrier.

21. The optical transmission system according to claim 18, wherein the frequency filtering is performed on the RF signal up-converted by the RF up-converter before the optical modulator up-converts the RF signal onto the optical carrier.

22. The optical transmission system according to claim 18, wherein the frequency filter has a static spectral profile corresponding to a pre-determined bandwidth.

23. The optical transmission system according to claim 18, wherein the frequency filter has a dynamically adjustable spectral profile, wherein the adjustable spectral profile is adjusted on-the-fly based on the frequency components of the signal being filtered.

24. The optical transmission system according to claim 18, wherein the frequency filter is at least one of:
a Nyquist filter;
a raised cosine filter;
a Gaussian filter;
a digital field programmable gate array filter; and
a digital fast Fourier transformation (FFT) filter.

25. The optical transmission system according to claim 16, further comprising an RF combiner, constructed to multiplex the RF signal generated by the RF up-converter with other RF signals carried on different RF sub-carriers.

26. The optical transmission system according to claim 16, further comprising a wavelength division multiplexer, adapted to multiplex the optical signal generated by the optical modulator with other optical signals carried in different wavelength channels.

27. An optical receiver unit, comprising:
an optical receiver;
an RF splitter in communication with the optical receiver;
an RF down-converter in communication with the RF splitter; and
a demodulator in communication with the RF down-converter, said demodulator adapted to produce a base-band bit stream from said down-converted RF signal,
wherein said RF splitter is adapted to receive other RF signals that are selectable in number to configure a received bit rate of said optical receiver unit.

28. A method for data transport, comprising:
selecting a number of RF signals according to a desired data transport rate;
multiplexing said number of RF signals to produce an aggregated, multilevel RF signal;
modulating an optical carrier with said aggregated, multilevel RF signals to produce an optical signal;
transmitting said optical signal from a first location to a second location; and
receiving said optical signal when it reaches said second location,
wherein said number of RF signals can be reselected to reconfigure said data transport rate.
